(19) United States
(12) Patent Application Publication
(10) Pub. No.: US 2004/0069328 A1
(43) Pub. Date: Apr. 15, 2004

(54) Gravity-return type cleaning apparatus for a car wash

(76) Inventor: Shiuh-You Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/270,365

(22) Filed: Oct. 15, 2002

(51) Int. Cl. B08B 3/00

(52) U.S. Cl. 134/45; 134/56 R; 134/113; 134/123; 134/151

(57) ABSTRACT

A car wash includes a frame, a guide rail device for moving the car to be washed, and a cleaning apparatus. The cleaning apparatus includes a pair of first cleaning mechanisms and a pair of second cleaning mechanisms. Each of the first cleaning mechanism and the second cleaning mechanisms includes a pivotal frame, a cleaning unit attached to the pivotal frame, and a return unit for returning the pivotal frame to its initial position. The pivotal frames are returned to their position by gravity.

### BACKGROUND OF THE INVENTION

1. Field of the Invention

The present invention relates to a cleaning apparatus for a car wash for cleaning vehicles, wherein the cleaning apparatus includes a plurality of cleaning units that are returned to their original positions by gravity.

2. Description of the Related Art

FIGS. 1 and 2 of the drawings illustrate a conventional car wash 1 for washing e.g., a car 2. The car wash 1 includes a frame 11 consisting of a plurality of beams, a sliding seat 12 mounted on top of the frame 11, a power source 13 for driving the sliding seat 12 to slide back and forth on the top of the frame 11, and two cleaning mechanisms 14 mounted to two ends of an underside of the sliding seat 12. The frame 11 defines a passageway allowing a vehicle to be washed to pass through. The sliding seat 12 is located above the passageway and extends along a width direction of the frame 11. The cleaning mechanisms 14 are located on two sides of the passageway and each includes an elongated vertical rotating shaft 141 attached to an end of the underside of the sliding seat 12, a power source 142 for swaying the rotating shaft 141 widthwise below the sliding seat 12, a power source 143 for rotating the rotating shaft 141, and a plurality of vertically aligned brush members 144 mounted on the rotating shaft 141. The power source 143 drives the rotating shaft 141 to turn and to revolve reciprocatingly over a predetermined range.

When washing a car 2, the rotating shaft 141 is driven by the power source 142 to sway, and the car 2 is moved forward into the frame 11. The brushing members 144 of the brushing mechanisms 14 are kept in contact with two sides of the car 2 while the car 2 is moving forward, thereby washing the sides of the car 2. When the rear end 23 of the car 2 passes through the brushing mechanism 14, the power source 13 moves the sliding seat 12 forward to tail the car 2 so that the brushing members 144 are kept in contact with and thus wash the rear end 23 of the car 2.

Since the cars to be washed have different lengths and widths, an operator must adjust the travel of the sliding seat 12 and preset the range for back and forth movement of the rotating shafts 141, which causes inconvenience to operation. Further, the overall structure of the car wash becomes more complicated when it is required to proceed with the adjustment, particularly the swaying travel of the rotating shafts 141, as a delicate control mechanism and associated electronic devices are required. Further, the delicate control mechanism and the electronic devices are apt to malfunction or even be damaged in this humid environment. Further, the moving travel and swaying travel of the rotating shafts 141 are still limited, rending poor application to cars that are too large or too small. Even though the rotating shafts 141 are designed to move and sway to a larger extent for washing a larger area, the car is either not easy to wash or apt to be damaged during washing.

### SUMMARY OF THE INVENTION

An object of the present invention is to provide a cleaning apparatus for a car wash for reliably and safely washing a vehicle, wherein the cleaning apparatus includes a plurality of cleaning units that are returned to their original positions by gravity.

In accordance with the present invention, a gravity-return type cleaning apparatus is provided for a car wash, the car wash being adapted to wash a car that is moved from a rear end of the car wash into the car wash, the car wash including a frame and a guide rail means mounted below the frame for moving the car forward, the frame including a plurality of vertical beams located on two sides of the guide rail means and a transverse beam connected between tops of said vertical beams. The cleaning apparatus in accordance with the present invention comprises:

a pair of first cleaning mechanisms, each said first cleaning mechanism being pivotally mounted to an inner side of an associated one of the vertical beams, each said first cleaning mechanism including a first pivotal frame mounted to the inner side of an associated one of the vertical beams, a first cleaning unit mounted to an end of the first pivotal frame that is distal to the associated vertical beam, a first pivotal power source for controlling pivotal movement of the first cleaning unit, a first push unit mounted between an associated one of the vertical beams and the first pivotal power source, a first pushing power source for controlling the first push unit to press against the first rotating frame, and a first return unit for returning the first pivotal frame to its original position; and

a pair of second cleaning mechanisms each of which is pivotally mounted to an inner side of an associated one of the vertical beams and located in front of an associated one the first cleaning mechanisms, each said second cleaning mechanism including a second pivotal frame mounted to the inner side of an associated one of the vertical beams, a second cleaning unit mounted to an end of the second pivotal frame, a second pivotal power source for controlling pivotal movement of the second cleaning unit, and a second return unit for returning the second pivotal frame to its original position;

when washing the car, each said first pushing power source actuates an associated one of the first push units to press against an associated one of the first pivotal frames, thereby causing each said first cleaning unit to pivot rearward about a pivotal joint of an associated one of the first pivotal frames;

when the car is moved forward by the guide rail means into the frame of the car wash, the first pushing power sources are turned off, the first pivotal frames are moved by the first return units back to their original position, the first cleaning units press against two sides and a rear end of the car in sequence during returning travel of the first pivotal frames;

when the car is further moved to the second cleaning mechanisms, the second cleaning mechanisms are moved away from each other by a front end of the car so that the second cleaning units move away from each other and that the second pivotal frames pivot forward and outward;

when the car leaves the frame via a front of the second cleaning mechanisms, the second return units pull the second pivotal frames back to their original position, and the second cleaning units press against the front end and the sides of the car during forward and outward pivotal movement of the second pivotal frames.

Other objects, advantages, and novel features of the invention will become more apparent from the following detailed description when taken in conjunction with the accompanying drawings.

### BRIEF DESCRIPTION OF THE DRAWINGS

FIG. 1 is a schematic side view of a conventional car wash.

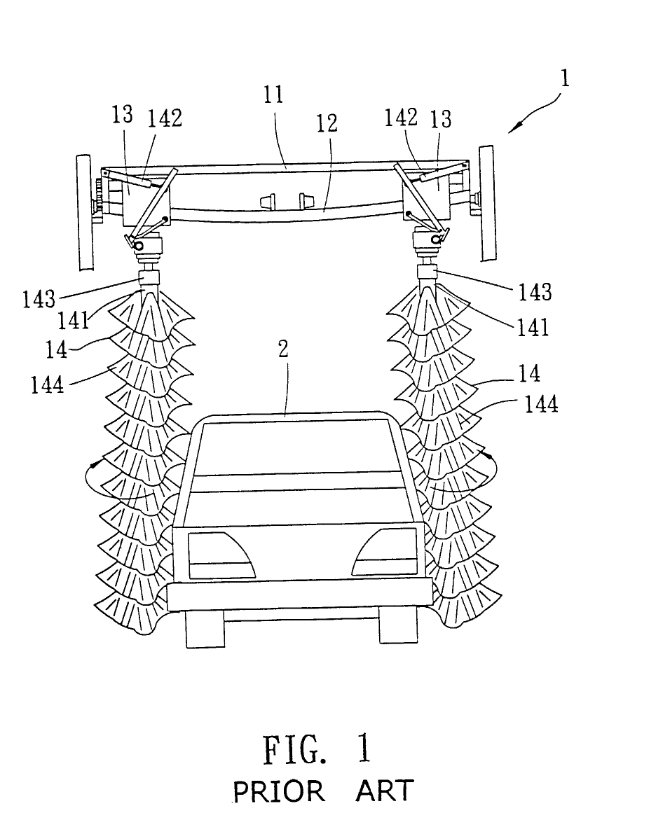

FIG. 2 is a schematic top view illustrating washing operation of the conventional car wash in FIG. 1.

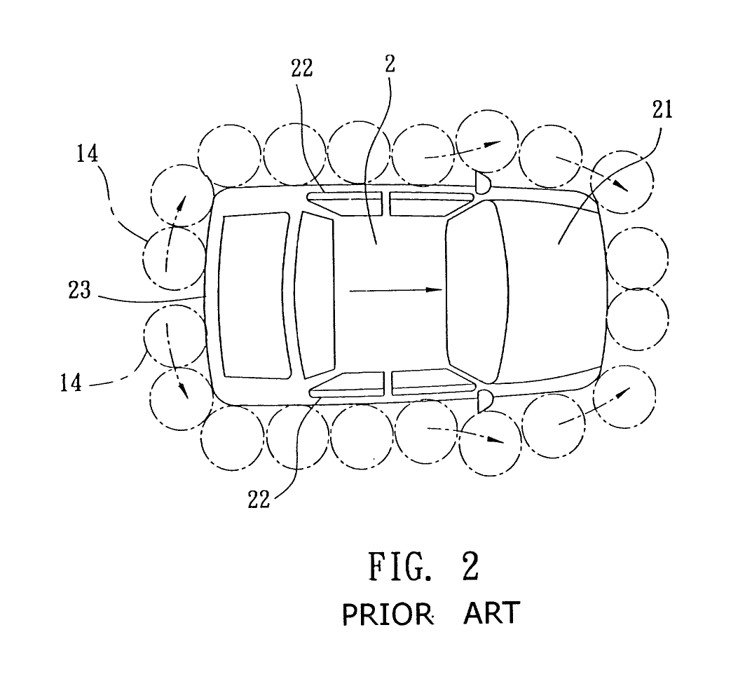

FIG. 3 is a perspective view of a car wash with a gravity-return type cleaning apparatus in accordance with the present invention.

FIG. 4 is a schematic top view of a car and the car wash in accordance with the present invention.

FIG. 5 is a perspective view of a portion of the car wash in accordance with the present invention.

FIG. 6 is a view similar to FIG. 4, wherein the car is moved into the car wash and located between a pair of first cleaning mechanisms of the car wash.

FIG. 7 is a view similar to FIG. 6, wherein the car is leaving the first cleaning mechanisms and is passing through a space between a pair of second cleaning mechanisms.

FIG. 8 is a view similar to FIG. 7, wherein the car has left the pair of first cleaning mechanisms and is located between the pair of second cleaning mechanisms.

### DETAILED DESCRIPTION OF THE PREFERRED EMBODIMENT

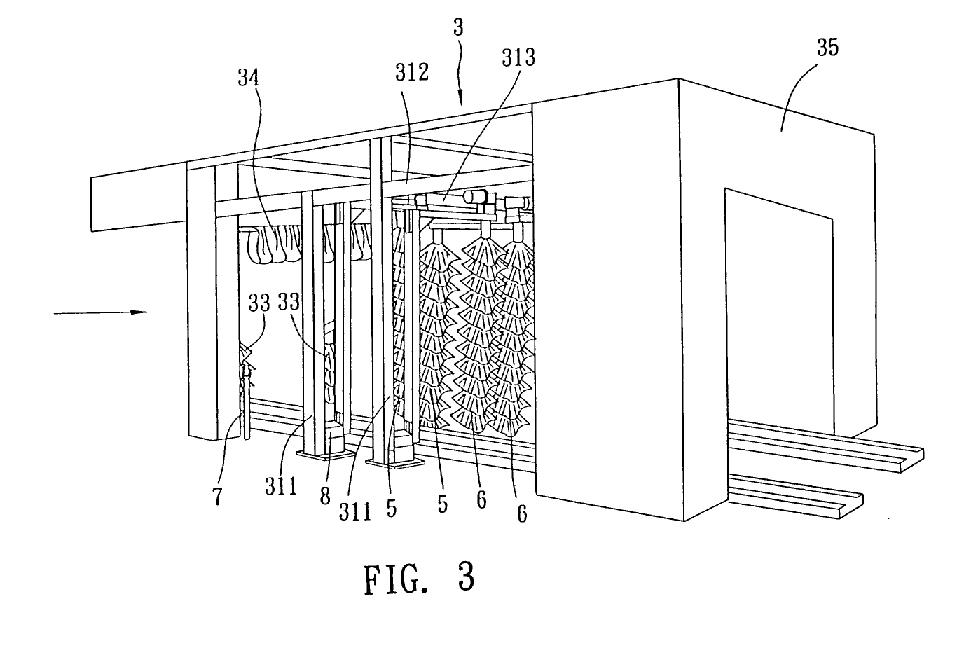

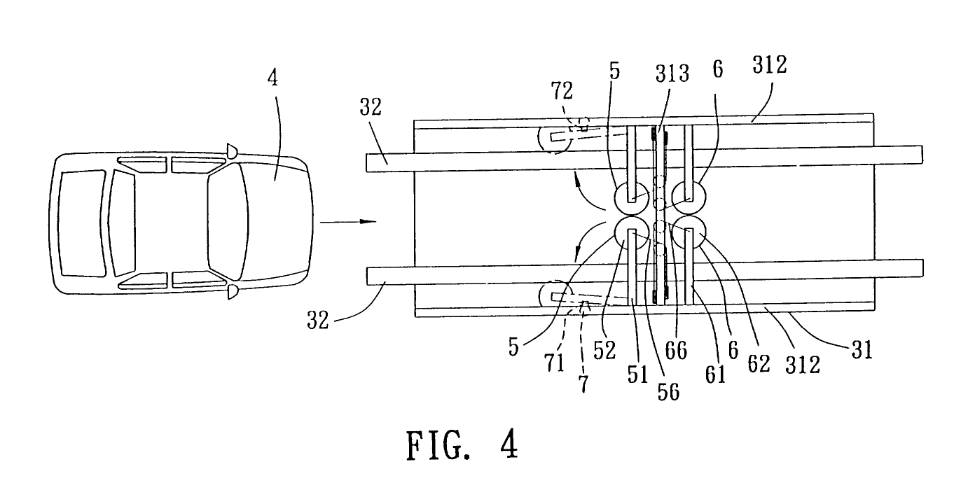

Referring to FIGS. 3 and 4, a preferred embodiment of a gravity-return type cleaning apparatus in accordance with the present invention is mounted in a war wash 3 for cleaning outside of a vehicle, such as a car 4. The car 4 moves forward from a rear end of the car wash 3. The car wash 3 includes a frame 31 consisting of a plurality of beams, and a pair of longitudinally extending guide rails 32 mounted below the frame 31. The frame 31 includes two rows of vertical beams 311 respectively located on two sides of the pair of guide rails 32, two side beams 312 respectively extending across tops of the two rows of vertical beams 311, and a transverse beam 313 connected between the side beams 312.

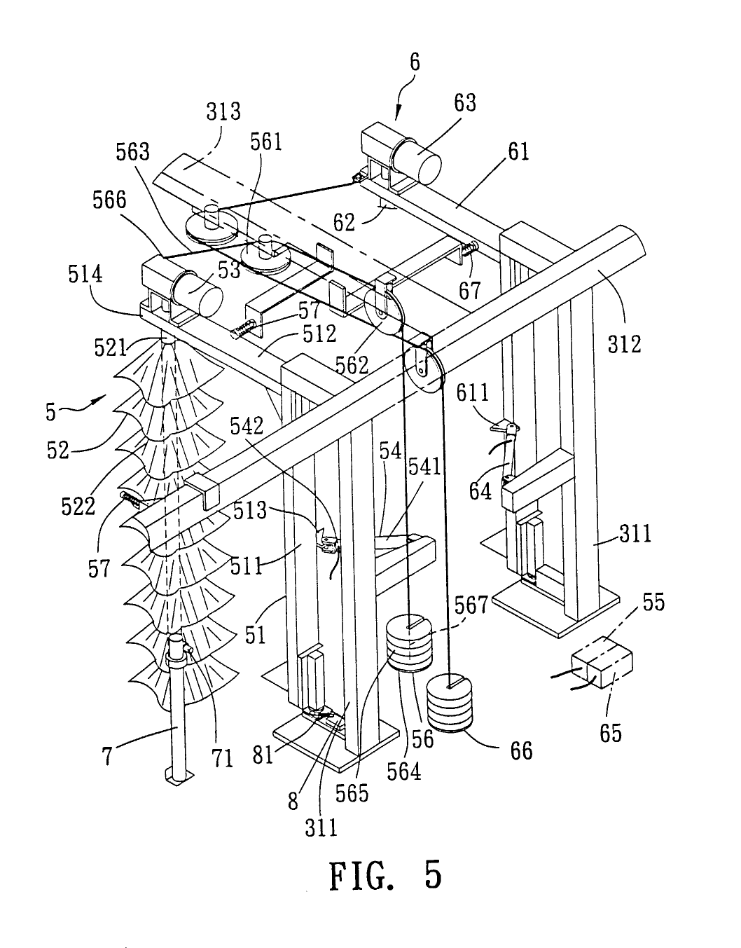

Referring to FIGS. 4 and 5, the car wash 3 further includes two lower cleaning units 33 respectively mounted to lower portions of two ends of a rear side of the frame 31, a top cleaning unit 34 mounted to a top portion of the rear side of the frame 31, and a drying unit 35 mounted to a top portion of a front side of the frame 31. The lower cleaning units 33 wash the wheels of the car 4, the top cleaning unit 34 washes a top of the car 4, and the drying unit 35 dries the washed car 4 by blowing air toward the washed car 4. These units schematically shown in FIG. 3 are not the feature of the invention, and detailed structures and operations of these units are thus omitted.

The car wash 3 further includes a cleaning apparatus including a pair of first cleaning mechanisms 5, a pair of second cleaning mechanisms 6, a sensing mechanism 7, and a safety mechanism 8. Each first cleaning mechanism 5 is pivotally mounted to an inner side of an associated vertical beam 311 and includes a first pivotal frame 51 mounted to an inner side of the associated vertical beam 311, a first cleaning unit 52 mounted to an end of the first pivotal frame 51 that is distal to the associated vertical beam 311, a first pivotal power source 53 for controlling pivotal movement of the first cleaning unit 52, a first push unit 54 mounted between the associated vertical beam 311 and the first pivotal power source 53, a first pushing power source 55 for controlling the first push unit 54 to press against the first rotating frame 51, a first return unit 56 for returning the first pivotal frame 51 to its original position, and two buffering/restraining units 57 for respectively restraining backward and forward pivotal positions of the first pivotal frame 51.

Each first pivotal frame 51 is a substantially inverted L-shaped frame disposed behind the transverse beam 313 and includes a vertical first pivotal rod 511 that is pivotally mounted to the inner side of the associated vertical beam 311, a first swaying rod 512 projecting from an upper end of the vertical first pivotal rod 511 and extending horizontally and inwardly away from the associated vertical beam 311, and a first extension rod 513 fixed to a front side of the first pivotal rod 511. The first swaying rod 512 includes a first connecting end 514 away from the first pivotal rod 511.

The first cleaning unit 52 is disposed to an underside of the first connecting end 514 of the first swaying rod 512 and includes a vertical rotatable shaft 521 mounted to the underside of the first connecting end 514 of the first swaying rod 512 and a plurality of vertically aligned brush members 522 mounted to and extended along a circumference of the rotatable shaft 521. Each brush member 522 may be an elongated cloth extending outward and having an appropriate length. Alternatively, a plurality of brush members 522 can be bundled and then fixed to the rotatable shaft 521. The first pivotal power source 53 is a motor mounted to the first swaying rod 512 and connected to the rotatable shaft 521 to thereby drive the rotatable shaft 521 about a longitudinal axis of the rotatable shaft 521, thereby turning the first cleaning unit 52. The first cleaning unit 52 and the first pivotal power source 53 are of a conventional design and therefore not described in detail.

Each first push unit 54 includes a pneumatic cylinder connected between the associated vertical beam 311 and the first pivotal frame 51. The pneumatic cylinder includes a cylinder 541 fixed to the associated vertical beam 311 and a piston rod 452 having a first end slidably received in the cylinder 541 and a second end attached to the first extension rod 513 of the first pivotal frame 51. The first pushing power source 55 may actuate the first push unit 54. When the first push unit 54 is actuated by the first pushing power source 55, the piston rod 542 pushes the extension rod 513 so that the first pivotal frame 51 pivots about the first rotating rod 511.

Each return unit 56 includes a horizontal pulley 561 fixed to a bottom of the horizontal beam 313, a vertical pulley 562 fixed to a vertical beam 311 adjacent to the horizontal beam 313, a cord 563 connected to the first swaying rod 512 of the first pivotal rod 51, a carrier plate 564 securely attached to a lower end 567 of the cord 563, and a weight 565 placed on the carrier plate 564. An upper end 566 of the cord 563 is fixed to a front side of the first pivotal power source 53, with the rope 563 being passing through the horizontal pulley 561 and the vertical pulley 562, and with the lower end 567 of the cord 563 being secured to the carrier plate 564. The weight 565 is selected to pivot the first pivotal frame 51 forward to its initial position.

The buffering/restraining units 57 are mounted on the frame 3 and spaced from each other. Each buffering/restraining unit 57 may be a pneumatic cylinder or compression spring for providing a buffering effect. One of the buffering/restraining units 57 is mounted to an inner side of an associated side beam 312 located in a rearward pivotal direction of the first pivotal frame 51. The buffering/restraining unit 57 is provided for restraining a rearmost position of the pivotal motion of the first pivotal frame 51. The other buffering/restraining unit 57 is mounted to a rear side of the horizontal beam 313 in association with a front side of the first swaying rod 512 of the first pivotal frame 51. The other buffering/restraining unit 57 is provided for restraining a foremost position of the pivotal motion of the first pivotal frame 51. Of course, the buffering/restraining units 57 may be mounted to front and rear sides of the first pivotal frame 51.

Each second cleaning mechanism 6 is pivotally mounted to an inner side of an associated vertical beam 311 and located in front of the first cleaning mechanism 5. The second cleaning mechanisms 6 face the horizontal beam 313. Each second cleaning mechanism 6 includes a second pivotal frame 61 mounted to an inner side of the associated vertical beam 311, a second cleaning unit 62 mounted to an end of the first pivotal frame 61 that is distal to the associated vertical beam 311, a second pivotal power source 63 for controlling pivotal movement of the second cleaning unit 62, a second push unit 64 mounted between the associated vertical beam 311 and the second pivotal power source 63, a second pushing power source 65 for controlling the second push unit 64 to press against the second pivotal frame 61, a second return unit 66 for returning the second pivotal frame 61 to its original position, and two buffering/restraining units 67 for respectively restraining backward and forward pivotal positions of the second pivotal frame 61.

The second pivotal frame 61, the second cleaning unit 62, the second rotating power source 63, the second push unit 64, the second pushing power source 65, the second return unit 66, and the buffering/restraining units 67 of each second cleaning mechanism 6 are substantially identical to those of the first cleaning mechanism 5 and therefore not described in detail to avoid redundancy. However, it is noted that the second return unit 66 is mounted between a rear side of the second pivotal frame 61 and the frame 31 for pivotal the second pivotal frame 61 rearward to its initial position. Further, the second extension rod 611 of the second pivotal frame 61 is located in the rear side, and the second push unit 64 is connected between the associated vertical beam 311 and the second extension rod 611. In a case that the car 4 has a flag projecting from a front end thereof and thus should not be washed at the front end, the second pushing power source 65 is activated to move the second push unit 64 so that the second pivotal frame 61 moves forward, allowing the front end of the car 4 to directly pass through the second cleaning mechanism 6 without being in contact with the second cleaning mechanism 6.

The sensing mechanism 7 is a photo sensor located behind the first cleaning mechanism 5 and located on two sides of the guide rails 32. The sensing mechanism 7 includes a transmitter 71 and a receiver 72 spaced from the transmitter 71. The transmitter 71 sends a signal to the receiver 72. When the signal from the transmitter 71 is received by the receiver 72, the receiver 72 is in a conductive state. When the car 4 is moving between the transmitter 71 and the receiver 72, the signal from the transmitter 71 could not be received by the receiver 72. The receiver 72 is thus in a non-conductive state, and the first pushing power source 55 is turned off. Of course, the sensing mechanism 7 may be an electric sensor or a contact-type sensor.

The safety mechanism 8 includes two limit switches 81 respectively mounted in the rearward pivotal directions of the first pivotal frames 51. When the first pivotal frames 51 pivot rearward and impinge the limit switches 81, the safety mechanism 8 sends a signal to urge the guide rails 32 to transport the car 4.

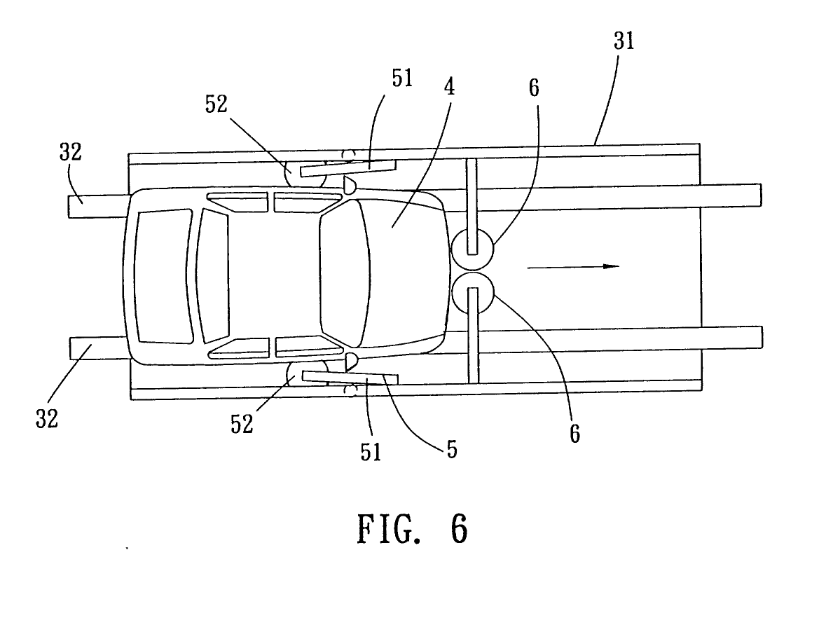

FIGS. 4 through 8 shows operation of the cleaning mechanisms, in which the car 4 is moved forward to pass through the car wash 3. Referring to FIG. 4, when washing the car 4, the first pushing power sources 55 activate the first push units 54 to press against the first pivotal frames 51. The first cleaning units 52 are moved by the first pivotal frames 51 and thus pivot rearward. The weight 565 of each first return unit 56 is lifted. When the first pivotal frames 51 come in contact with the safety mechanism 8, the guide rails 32 are actuated to transport the car 4 forward into the frame 31. Referring to FIG. 6, when the sensing mechanism 7 detects passing of the car 4, the first pushing power sources 55 are turned off to stop pressing function of the first push units 54. The first return units 56 pull the first pivotal frames 51 forward to their original position under the gravity of the weights 565. The first cleaning units 52 press against two sides and a rear end of the car 4 in sequence during the returning travel of the first pivotal frames 51, thereby washing the sides and the rear end of the car 4.

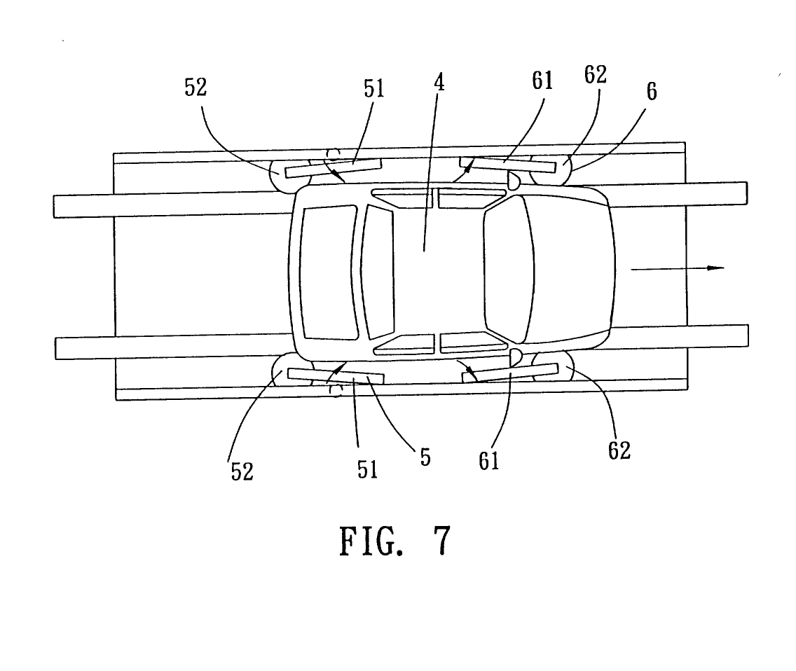

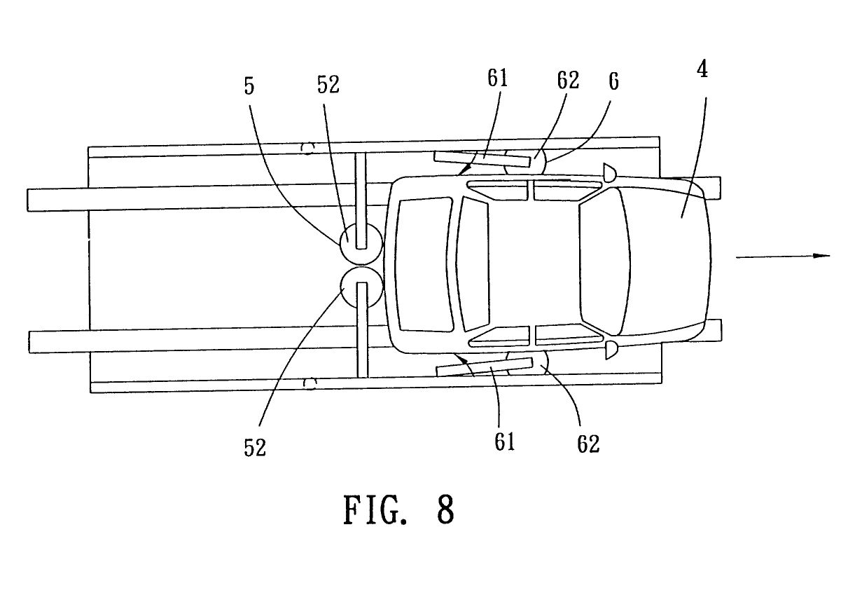

Referring to FIG. 7, when the car 4 continues to move forward to the second cleaning mechanisms 6, the front end of the car 4 pushes and thus separates the second cleaning mechanisms 6 so that the second pivotal frames 61 pivots outward and forward, allowing the car 4 to enter the space between the second cleaning units 62. Referring to FIG. 8, after the car 4 has passed through the first cleaning mechanisms 6, the first pivotal frames 51 are pulled forward by the first return units 56 to their original position under the gravity of the weights 565. When the car 4 continues to move forward and thus leave the frame 31 via the second cleaning mechanisms 6, the second return units 66 move the second pivotal frames 61 to their original position under the gravity of the weights of the second return units 66. The front end and two sides of the car 4 are washed by the second cleaning units 62 when the second cleaning units 62 are pushed away by the car 4 that is moved forward.

According to the above description, by means of providing the first and second return units 56 and 66 using gravity, the associated first and second pivotal frames 51 and 62 can be pivoted so that the first and second cleaning units 62 move along a periphery of the car. Thus, the car is reliably washed regardless of the size of the car, as the car stalls and is thus in contact with the first and second cleaning units 52 and 66 for a sufficient period of time without scratching the car. Thus, the cleaning apparatus in accordance with the present invention is simple in structure while providing a reliable washing effect. Further, the cleaning force provided by the first and second cleaning units 52 and 62 are uniform, as the first and second pivotal frames 51 and 61 are pulled by forces of a predetermined magnitude, with the first and second cleaning units 52 and 62 being moved along a periphery of the car 4. Further, the washing force can be adjusted according to need by means of adjusting the weight 565.

Although the invention has been explained in relation to its preferred embodiment, it is to be understood that many other possible modifications and variations can be made without departing from the scope of the invention as hereinafter claimed.

What is claimed is:

1. A gravity-return type cleaning apparatus for a car wash, the car wash being adapted to wash a car that is moved from a rear end of the car wash into the car wash, the car wash including a frame and a guide rail means mounted below the frame for moving the car forward, the frame including a plurality of vertical beams located on two sides of the guide rail means and a transverse beam connected between tops of said vertical beams, the cleaning apparatus comprising:
a pair of first cleaning mechanisms, each said first cleaning mechanism being pivotally mounted to an inner side of an associated one of the vertical beams, each said first cleaning mechanism including a first pivotal frame mounted to the inner side of an associated one of the vertical beams, a first cleaning unit mounted to an end of the first pivotal frame that is distal to the associated vertical beam, a first pivotal power source for controlling pivotal movement of the first cleaning unit, a first push unit mounted between an associated one of the vertical beams and the first pivotal power source, a first pushing power source for controlling the first push unit to press against the first rotating frame, and a first return unit for returning the first pivotal frame to its original position; and
a pair of second cleaning mechanisms each of which is pivotally mounted to an inner side of an associated one of the vertical beams and located in front of an associated one the first cleaning mechanisms, each said second cleaning mechanism including a second pivotal frame mounted to the inner side of an associated one of the vertical beams, a second cleaning unit mounted to an end of the second pivotal frame, a second pivotal power source for controlling pivotal movement of the second cleaning unit, and a second return unit for returning the second pivotal frame to its original position;
when washing the car, each said first pushing power source actuates an associated one of the first push units to press against an associated one of the first pivotal frames, thereby causing each said first cleaning unit to pivot rearward about a pivotal joint of an associated one of the first pivotal frames;
when the car is moved forward by the guide rail means into the frame of the car wash, the first pushing power sources are turned off, the first pivotal frames are moved by the first return units back to their original position, the first cleaning units press against two sides and a rear end of the car in sequence during returning travel of the first pivotal frames;
when the car is further moved to the second cleaning mechanisms, the second cleaning mechanisms are moved away from each other by a front end of the car so that the second cleaning units move away from each other and that the second pivotal frames pivot forward and outward;
when the car leaves the frame via a front of the second cleaning mechanisms, the second return units pull the second pivotal frames back to their original position, and the second cleaning units press against the front end and the sides of the car during forward and outward pivotal movement of the second pivotal frames.

2. The gravity-return type cleaning apparatus for a car wash as claimed in claim 1, further comprising a sensing mechanism mounted behind the first cleaning mechanisms, when the sensing mechanism detects that the car has reached a predetermined position, the first pushing power sources are turned off for returning the first cleaning units.

3. The gravity-return type cleaning apparatus for a car wash as claimed in claim 1, further comprising a safety mechanism including two limit switches respectively mounted in rearward pivotal directions of the first pivotal frames, wherein when the firs pivotal frames pivot rearward and impinge the limit switches, a signal is sent to urge the guide rail means to move the car forward.

4. The gravity-return type cleaning apparatus for a car wash as claimed in claim 1, wherein the first return unit of each said first cleaning mechanism includes a cord having an upper end fixed to the first pivotal frame and a lower end that is away from the first pivotal frame and that extends vertically, a weight being attached to the lower end of the cord, the cord extending horizontally through the horizontal beam.

5. The gravity-return type cleaning apparatus for a car wash as claimed in claim 1, wherein the second return unit of each said second cleaning mechanism includes a cord having an upper end fixed to the second pivotal frame and a lower end that is away from the second pivotal frame and that extends vertically, a weight being attached to the lower end of the cord, the cord extending horizontally through the horizontal beam.

6. The gravity-return type cleaning apparatus for a car wash as claimed in claim 1, wherein the first pivotal frame of each said first cleaning mechanism includes a substantially inverted L-shaped frame having a vertical pivotal rod pivotally mounted to the inner side of an associated one of the vertical beams, and a swaying rod projecting from an upper end of the vertical pivotal rod and extending horizontally and inwardly away from an associated one of the vertical beams, the first cleaning unit being mounted to a bottom of the swaying rod.

7. The gravity-return type cleaning apparatus for a car wash as claimed in claim 1, wherein the second pivotal frame of each said second cleaning mechanism includes a substantially inverted L-shaped frame having a vertical pivotal rod pivotally mounted to the inner side of an associated one of the vertical beams, and a swaying rod projecting from an upper end of the vertical pivotal rod and extending horizontally and inwardly away from an associated one of the vertical beams, the second cleaning unit being mounted to a bottom of the swaying rod.

8. The gravity-return type cleaning apparatus for a car wash as claimed in claim 1, wherein each said first cleaning mechanism further includes two buffering/restraining units for respectively restraining backward and forward pivotal positions of the first pivotal frame, one of the buffering/restraining units being mounted to the frame and located in a rearward pivotal direction of the first pivotal frame for restraining a rearmost position of the pivotal motion of the first pivotal frame, the other buffering/restraining unit being mounted to the frame and located in a forward pivotal direction of the first pivotal frame for restraining a foremost position of the pivotal motion of the first pivotal frame.

9. The gravity-return type cleaning apparatus for a car wash as claimed in claim 1, wherein each said second cleaning mechanism further includes two buffering/restraining units for respectively restraining backward and forward pivotal positions of the second pivotal frame, one of the buffering/restraining units being mounted to the frame and located in a rearward pivotal direction of the second pivotal frame for restraining a rearmost position of the pivotal motion of the second pivotal frame, the other buffering/restraining unit being mounted to the frame and located in a forward pivotal direction of the second pivotal frame for restraining a foremost position of the pivotal motion of the second pivotal frame.

10. The gravity-return type cleaning apparatus for a car wash as claimed in claim 1, wherein said first push unit of each said first cleaning mechanism is a pneumatic cylinder.

11. The gravity-return type cleaning apparatus for a car wash as claimed in claim 2, wherein the sensing mechanism is a photo sensor including a transmitter and a receiver spaced from the transmitter, the transmitter keeping sending a signal to the receiver.

12. The gravity-return type cleaning apparatus for a car wash as claimed in claim 1, wherein each said second cleaning mechanism further includes a second push unit mounted between an associated one of the vertical beams and the second pivotal power source, each said second cleaning mechanism further including a second pushing power source for controlling the second push unit to press against the second pivotal frame, thereby causing the second cleaning unit to pivot forward about a pivotal joint of the second pivotal frame.
